(19) United States
(12) Patent Application Publication
(10) Pub. No.: US 2018/0330742 A1
(43) Pub. Date: Nov. 15, 2018

(54) SPEECH ACQUISITION DEVICE AND SPEECH ACQUISITION METHOD

(71) Applicant: OLYMPUS CORPORATION, Tokyo (JP)

(72) Inventor: Kazutaka TANAKA, Tokyo (JP)

(73) Assignee: OLYMPUS CORPORATION, Tokyo (JP)

(21) Appl. No.: 15/969,024

(22) Filed: May 2, 2018

(30) Foreign Application Priority Data
May 11, 2017 (JP) 2017-094457

(51) Int. Cl. G10L 21/02; G10L 25/84; G10L 21/0232; H04R 1/32

(52) U.S. Cl. CPC G10L 21/0205; H04R 1/326; G10L 21/0232; G10L 25/84

(57) ABSTRACT

A speech acquisition device, comprising a microphone for converting speech to voice data, and a sound quality adjustment circuit that adjusts sound quality of the voice data, wherein the sound quality adjustment circuit performs different sound quality adjustment in a case where a transcript is created using speech recognition and in a case where a transcript is created by a person listening to speech.

### CROSS-REFERENCE TO RELATED APPLICATIONS

Benefit is claimed, under 35 U.S.C. § 119, to the filing date of prior Japanese Patent Application No. 2017-094457 filed on May 11, 2017. This application is expressly incorporated herein by reference. The scope of the present invention is not limited to any requirements of the specific embodiments described in the application.

### BACKGROUND OF THE INVENTION

### 1. Field of the Invention

The present invention relates to a speech acquisition unit that begins writing speech to characters using speech recognition or a person, and to a speech acquisition method and a program for voice acquisition.

### 2. Description of the Related Art

Conventionally, for example, so-called transcription has been performed in corporations, hospitals, lawyers offices or the like, whereby a user stores voice data using a voice recording device such as an IC recorder, this voice data file is played back, and the played back content is typed into a document while listening to the reproduced sound. Also, speech recognition technology has improved in recent years, and it has become possible to perform dictation where voice data that stores speech is analyzed, and a document created. It should be noted that with this specification a user who performs transcription is called a transcriptionist, and a unit that is suitable for performing transcription is called a transcriber unit. Also, a unit that creates documents using speech recognition is called a dictation unit. Further, a result of converting speech to text or to a document using a transcriber unit or a dictation unit is called a transcript.

Technology has been proposed whereby a transcriptionist plays back stored voice data using a transcriber unit, and in a case of creating a document while listening to this reproduced sound (transcription) it is possible to listen clearly to speech (refer, for example, to Japanese patent laid-open No. Hei 6-175686 (hereafter referred to as “patent publication 1”)). Further, there have also been various proposals for technology to remove noise from speech.

Speech processing technology so as to give few errors when automatically making speech into a document using speech recognition (for example, noise removal), and speech processing technology for reproducing clear speech when making speech into a document with a person listening to reproduced sound (for example, noise removal), are different. For example, in a case where a person makes a document by listening to reproduced sound using a transcriber unit, it is best to remove noise sounds as much as possible to give clear speech. On the other hand, in the case of making a document using speech recognition with a machine (dictation unit), if noise removal is performed strongly, characteristics of the speech will be lost and recognition rate is lowered.

### SUMMARY OF THE INVENTION

The present invention provides a speech acquisition unit, a speech acquisition method, and a program for speech acquisition that perform speech storage appropriate to respective characteristics in a case where a transcript is created by a person listening to speech with their ears, and a case where a transcript is created by a machine from voice data using speech recognition.

A speech acquisition device of a first aspect of the present invention comprises a microphone for converting speech to voice data, and a sound quality adjustment circuit for adjusting sound quality of the voice data, wherein the sound quality adjustment circuit performs different sound quality adjustment in a case where a transcript is created using speech recognition and in a case where a transcript is created by a person listening to speech.

A speech acquisition method of a second aspect of the present invention comprises converting speech to voice data, and performing different sound quality adjustment of the voice data in a case where a transcript is created using speech recognition, and in a case where a transcript is created by a person listening to speech.

### BRIEF DESCRIPTION OF THE DRAWINGS

FIG. 1 is a block diagram mainly showing the electrical structure of a dictation and transcriber system of one embodiment of the present invention.

FIG. 2 is a cross sectional drawing showing internal structure of an information acquisition unit of one embodiment of the present invention.

FIG. 3 is a block diagram showing the structure of an electrical circuit for separately acquiring noise and speech using an information acquisition unit of one embodiment of the present invention.

FIG. 4A and FIG. 4B are flowcharts showing main operation of an information acquisition unit of one embodiment of the present invention.

FIG. 5 is a flowchart showing operation of a description section and a recording and reproduction device of one embodiment of the present invention.

FIG. 6 is a flowchart showing operation of machine type speech recognition of the description section of one embodiment of the present invention.

FIG. 7 is a flowchart showing transcriber operation performed by a person listening to speech, in one embodiment of the present invention.

FIG. 8A to FIG. 8D are graphs for describing noise removal in one embodiment of the present invention.

FIG. 9 is a drawing showing file structure of a voice file in one embodiment of the present invention.

FIG. 10A and FIG. 10B are drawings for describing mode setting in accordance with installation of an information acquisition unit, in one embodiment of the present invention.

### DETAILED DESCRIPTION OF THE PREFERRED EMBODIMENTS

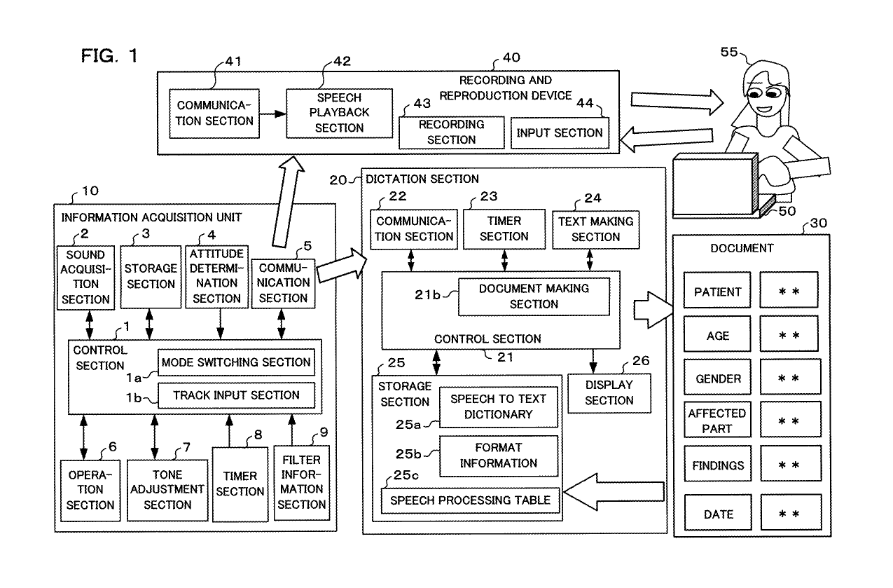

In the following, an example of the present invention applied to a dictation and transcriber system will be described as one embodiment of the present invention. As shown in FIG. 1, this dictation and transcribe a system comprises an information acquisition unit 10, a dictation section 20, a document 30 and a recording and reproduction device 40.

In this embodiment an example where an IC recorder is used will be described as the information acquisition unit 10. However, the information acquisition unit 10 is not limited to an IC recorder and may be a unit having a recording function, such as a smartphone, personal computer (PC), tablet etc. Also, with this embodiment, the dictation section 20, document 30 and recording and reproduction device 40 are provided by a personal computer (PC) 50 serving these functions. However, the dictation section 20 may also be a dedicated unit, or the information acquisition unit 10 may be concurrently used as the dictation section 20. Also, the document 30 is stored in memory within the PC 50, but this is not limiting, and the document 30 may also be stored in memory such as dedicated hard disk. Further, the information acquisition unit 10 and the recording and reproduction device 40 may be provided within the same device, and the information acquisition unit 10 and the dictation section 20 may also be provided within the same unit.

Also, with this embodiment the dictation and transcriber system is constructed in a stand-alone manner. This is not limiting, however, and some or all of the dictation section 20, document 30 and recording and reproduction device 40 may be connected by means of the Internet. In this case, a server in the cloud may provide functions of some or all of the above-mentioned sections. Also, some or all of these sections may be connected to an intranet within a company, hospital, legal or patent office, construction company, government office etc., and functions of these sections may be provided by a server within that intranet.

The information acquisition unit 10 acquires voice data using a sound collection section 2, and applies processing to the voice data that has been acquired so as to give voice data that has optimum characteristics in accordance with a type etc. of transcript that has been set.

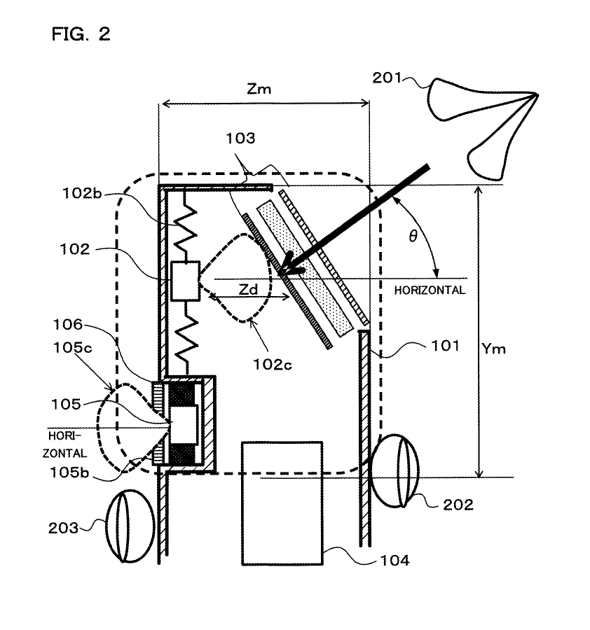

The sound collection section 2 within the information acquisition unit 10 has a microphone, speech processing circuit etc. The sound collection section 2 converts speech that has been collected by the microphone to an analog signal, and applies analog speech processing such as amplification to the analog signal. After this analog speech processing, the sound collection section 2 subjects analog speech to analog to digital conversion, and outputs voice data that has been made into digital data to the control section 1. The microphone of this embodiment has a microphone for noise removal (for NR) arranged, as will be described later using FIG. 2. As a result, when the user has performed recording of speech in the vicinity of the microphone, the sound collection section 2 can remove unwanted noise such as pop noise that arises as a result of a breath and wind impinging on a microphone. The microphone within the sound collection section 2 functions as a microphone for converting speech to voice data. The microphone can also have its directional range made different.

A storage section 3 has electrically rewritable volatile memory and electrically rewritable non-volatile memory. This storage section 3 stores voice data that has been acquired by the sound collection section 2 and subject to voice data processing by the control section 1. Various adjustment values etc. that are used in the sound quality adjustment section 7, which will be described later, are also stored. It should be noted that various adjustment values used in the sound quality adjustment section 7 may also be stored in a file information section 9. The storage section 3 also stores programs for a CPU (Central Processor Unit) within the control section 1. It should be noted that by storing voice data in an external storage section 43 by means of a communication section 5, it is possible to omit provision of the storage section 3 within the information acquisition unit 10.

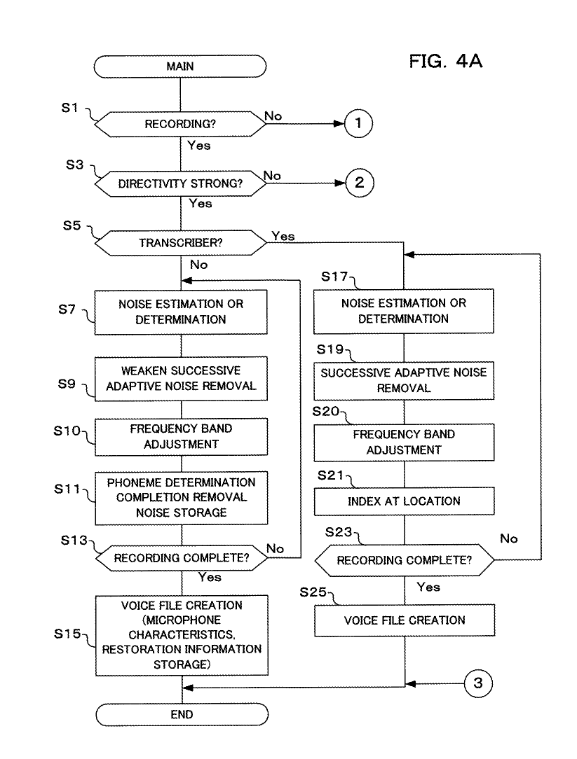

The storage section 3 (or file information section 9) functions as memory for storing sound acquisition characteristic information relating to sound acquisition characteristics of the sound acquisition section (microphone) and/or restoration information. The storage section 3 functions as storage for storing voice data that has been adjusted by the sound quality adjustment section. This storage respectively stores two sets of voice data for which respectively appropriate sound quality adjustment has been performed, for a case where a transcript is created using speech recognition, and a case where a transcript is created by a person listening to speech, in parallel (recording of S7 and onwards in FIG. 4A and recording of step S17 and onwards in FIG. 4A are carried out in parallel).

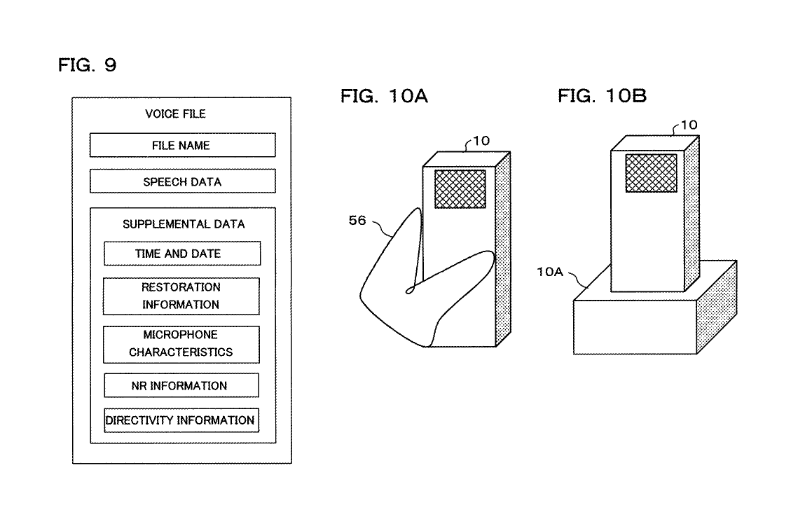

An attitude determination section 4 has sensors such as a Gyro, acceleration sensor etc. The attitude determination section 4 detects movement that is applied to the information acquisition unit 10 (vibration, hand shake information), and/or detects attitude information of the information acquisition unit 10. As this attitude information, for example, whether a longitudinal direction of the information acquisition unit 10 is a vertical direction or is a horizontal, etc. is detected. As will be described later using FIG. 10, whether or not the information acquisition unit 10 is installed in a stand is determined based on hand shake information that has been detected by the attitude determination section 4.

The communication section 5 has communication circuits such as a transmission circuit/reception circuit. The communication section 5 performs communication between a communication section 22 within the dictation section 20 and a communication section 41 within the recording and reproduction device 40. Communication between the dictation section 20 and the recording and reproduction device 40 may be performed using wired communication by electrically connecting using communication cables, and may be performed using wireless communication that uses radio waves or light etc.

An operation section 6 has operation buttons such as a recording button for commencing speech storage, and has a plurality of mode setting buttons for setting various modes at the time of recording. As mode settings there a mode for setting recording range directivity, a mode for setting noise removal level, a transcript setting mode etc. The transcript setting mode is a mode for, when creating a transcript, selecting either a recording system that is suitable to being performed by a person, or a recording system that is appropriate to being performed automatically (recording suitable for speech recognition use). Also, the operation section 6 has a transmission button for transmitting a voice file to an external unit such as the dictation section 20 or the recording and reproduction device 40.

With this embodiment, mode settings are set by the user operating operation buttons of the operation section 6 while looking at display on a monitor screen of the PC 50. Since a combination of directivity and transcript setting mode is often used, with this embodiment setting is possible using a simple method, as described in the following. Specifically, a first mode for a wide range of directivity, a second mode for machine type transcript in a narrow range of directivity, and a third mode for transcript by a person in a narrow range of directivity, are prepared. Then, when first and second operating buttons among the plurality of operating buttons of the operation section have been pressed down simultaneously, mode display is cyclically changed sequentially from the first mode to the third mode at given time intervals (displayed using a display section such as LEDs), and when a mode that the user wants to set appears the pressing of the operating buttons at the same time is released.

The sound quality adjustment section 7 has a sound quality adjustment circuit, and digitally adjusts sound quality of voice data that has been acquired by the sound collection section 2. In a case where speech is converted to text (phonemes) using speech recognition, the sound quality adjustment section 7 adjusts sound quality so that it is easy to recognize phonemes. It should be noted that phonemes are the smallest unit in phonetics, corresponding to a single syllable such as a vowel or consonant, and normally corresponding to a single alphabetic letter of a phonetic symbol (phonetic sign, phonemic symbol).

The sound quality adjustment section 7 may remove noise that is included in the voice data. As will be described later, a level of noise removal is different depending on whether a transcript is created by machine type speech recognition or whether a transcript is created by a person (refer to S9 and S19 in FIG. 4A). In a case where noise removal is accomplished by subtracting data resulting from multiplication of noise data by a weighting coefficient (smaller than 1) from input voice data, the level of noise removal can be changed by varying a value of the weighting coefficient. Specifically, if a value of weighting coefficient is large noise removal is strong, while if a value of weighting coefficient his small noise removal is weak.

Also, the sound quality adjustment section 7 performs sound quality adjustment by changing a frequency band of the voice data. For example, in a case where speech recognition is performed by the dictation section 20 (dictation unit) and a transcript is created, the sound quality adjustment section 7 makes voice data in a speech band of 200 Hz to 10 kHz. On the other hand in a case where a transcript is created by a person listening to speech using a playback and recording device 40 (transcriber unit), the sound quality adjustment section 7 makes voice data in a speech band of 400 Hz to 8 kHz. When pronouncing vowels, people's resonance characteristic varies, and this resonant frequency at an amplitude spectral peak is called a formant frequency, with resonant frequencies sequentially being called first formant, second formant etc. from the lower resonant frequency. The first formant of a vowel is close to 400 Hz, and since speech is recognized by changing the second formant, in the case of a person listening to speech, frequencies close to this 400 Hz are emphasized, and cutting low frequencies and high frequencies as much as possible is easier to listen to. On the other hand, in the case where speech recognition is performed by a machine, if a frequency domain that is cut is wide frequency distribution patterns to be detected are disrupted, and it becomes difficult to recognize as phonemes. It should be noted that the above described frequency bands are examples, and while the present invention is not limited to the described numerical values it is preferable for a dictation unit to be able to store lower frequencies than a transcriber unit.

Also, the sound quality adjustment section 7 may perform adjustment for each individual that is a subject of speech input, so as to give the most suitable sound quality for creating a transcript. In a case of vocalizing the same character also, since there are individual differences in pronunciation characteristics for each individual may be stored in advance in memory (refer to S41 to S49 in FIG. 4B), and speech recognition performed by reading this characteristic for an individual from memory. Also, the sound quality adjustment section 7 may perform sound quality adjustment by automatically recognizing, or by having manually input, various conditions, such as adult or child, male or female, an accent used locally, a professional person such as an announcer or an ordinary person, etc.

The sound quality adjustment section 7 functions as a sound quality adjustment circuit that adjusts the sound quality of voice data. This sound quality adjustment circuit performs different sound quality adjustment for a case where a transcript is created using speech recognition and a case where a transcript is created by a person listening to speech (refer to S9 and S19 in FIG. 4A). Also, this sound quality adjustment circuit performs removal of noise components that is superimposed on voice data, and further makes a degree of removal of noise components or removal method for noise components different in a case where a transcript is created using speech recognition and in a case where a transcript is created by a person listening to speech (refer to S9 and S19 in FIG. 4A). This sound quality adjustment circuit also performs adjustment of frequency band of the voice data, and further makes a frequency band range different for a case where a transcript is created using speech recognition and a case where a transcript is created by a person listening to speech (refer to S10 and S20 in FIG. 4A).

Also, the sound quality adjustment circuit makes sound quality adjustment different based on sound acquisition characteristic information and/or restoration information (refer to S9 and S19 in FIG. 4A etc.). The sound quality adjustment circuit performs removal of noise components that are superimposed on the voice data. The dictation section restores voice data based on noise components that have been removed, and performs speech recognition based on this restored voice data. The sound quality adjustment circuit makes sound quality adjustment different depending on directional range of the microphone.

The timer section 8 has a clock function and a calendar function. The control section 1 is input with time and date information etc. from the timer section 8, and when voice data is stored in the storage section 3 the time and date information is also stored. Storing time and date information is convenient in that it is possible to search for voice data at a later date based on the time and date information.

The file information section 9 has an electrically rewritable nonvolatile memory, and stores characteristics of a filter section 103 and a second filter section 106, which will be described later using FIG. 2. Sound quality will be changed as a result of speech passing through the filter section 103 and second filter section 106 of this embodiment. For example, voice data of a given frequency is attenuated and a frequency band is changed by the filter section. Therefore, when the sound quality adjustment section 7 performs adjustment of speech, characteristics that have been stored are used, and optimum sound quality adjustment is performed depending on whether a transcript is created by a dictation unit, or a transcript is created using a transcriber unit. It should be noted that characteristics of filters and microphones etc. stored by the file information section 9 are transmitted to the dictation section 20 etc. by means of the communication section 5.

The control section 1 has a CPU and CPU peripheral circuits, and performs overall control within the information acquisition unit 10 in accordance with programs that have been stored in the storage section 3. There are a mode switching section 1a and a track input section (phrase determination section) 1b within the control section 1, and each of these sections is implemented in a software manner by the CPU and programs. It should be noted that these sections may also be implemented in a hardware manner by peripheral circuits within the control section 1.

The mode switching section 1a performs switching so as to execute a mode that has been designated by the user with the operation section 6. The mode switching section 1a switches whether recording range is a wide range or a narrow range (refer to S3 in FIG. 4A), for example, and performs switching setting of a mode for whether a transcript is created by a person using a transcriber unit or whether a transcript is created by a dictation unit using speech recognition (S5 in FIG. 4A) etc.

The track input section 1b store indexes at locations constituting marks for breaks in speech, as a result of manual operation by the user. Besides this index storing method, indexes may also be stored automatically at fixed intervals, and breaks in speech may be detected based on voice data (phrase determination) and indexes stored. The track input section 1b can perform phrase determination. At the time of storing voice data these breaks (indexes) are also stored. Also, at the time of storing indexes recording time and date information from the timer section 8 may also be stored. Storing indexes is advantageous when the user is cuing while listening to speech, after speech storage.

It should be noted that there is only a recording function within the information acquisition unit 10 show in FIG. 1, but a function for playing back voice data that has been stored in the storage section 3 may also be provided, and not only the recording function. In this case, a speech playback circuit, speaker, etc. should be added. A playback button for performing speech playback, a fast-forward button for performing fast-forward, a fast rewind button for performing fast rewind etc. should also be provided in the operation section 6.

The dictation section 20 is equivalent to the previously described dictation unit, and makes voice data that has been acquired by the information acquisition unit 10 into a document in a machine type manner using speech recognition. As was described previously, the dictation section 20 may be a dedicated unit, but with this embodiment is realized using the PC 50.

The communication section 22 has communication circuits such as a transmission circuit/reception circuit, and performs communication with a communication section 5 of the information acquisition unit 10 to receive voice data etc. that has been acquired by the information acquisition unit 10. Communication with the information acquisition unit 10 may be wired communication performed by electrically connecting using communication cables, and may be wireless communication performed using radio waves or light etc. It should be noted that the communication section 22 receives information that is used at the time of speech recognition, such as characteristic information of microphones and filters etc., and individual characteristics, from the information acquisition unit 10, and these items of information are stored in the recording section 25.

A timer section 23 has a timer function and a calendar function. The control section 21 is input with time and date information etc. from the timer section 23, and stores creation time and date information etc. in the case of creating a document using a document making section 21b.

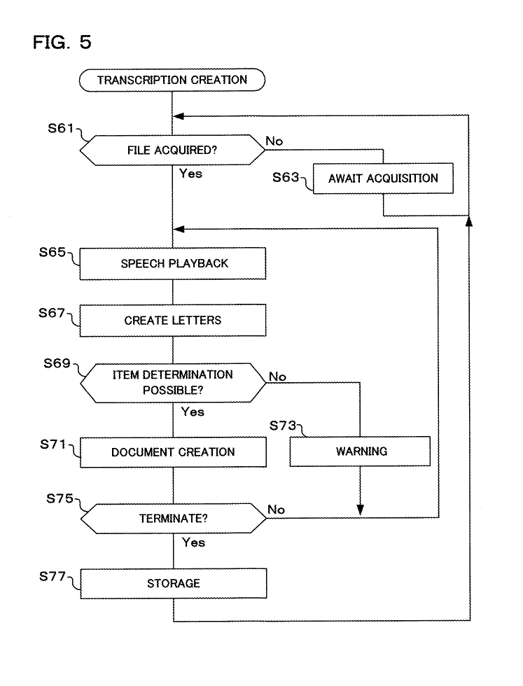

A text making section 24 uses speech recognition to create text data from voice data that has been acquired by the information acquisition unit 10. Creation of this text data will be described later using FIG. 6. It should be noted that the text making section 24 may be realized in software by the control section 21, and may be realized in hardware in the text making section 24.

The recording section 25 has an electrically rewritable nonvolatile memory, and has storage regions for storing a speech to text dictionary 25a, format information 25b, a speech processing table 25c etc. Besides the items described above, there is also a phoneme dictionary for determining whether or not data that has been subjected to phoneme Fourier transformation matches a phoneme (refer to S89 and S85 in FIG. 6). It should be noted that besides these storage regions the recording section 25 has a storage region for storing various information, such as programs for causing operation of the CPU within the control section 21.

The speech to text dictionary 25a is a dictionary that is used when phonemes are extracted from voice data and combinations of these phonemes are converted to characters (refer to S93, S97 and S99 in FIG. 6). It is also a dictionary that is used when combinations of characters are recognized as words (refer to S101 and S109 in FIG. 6).

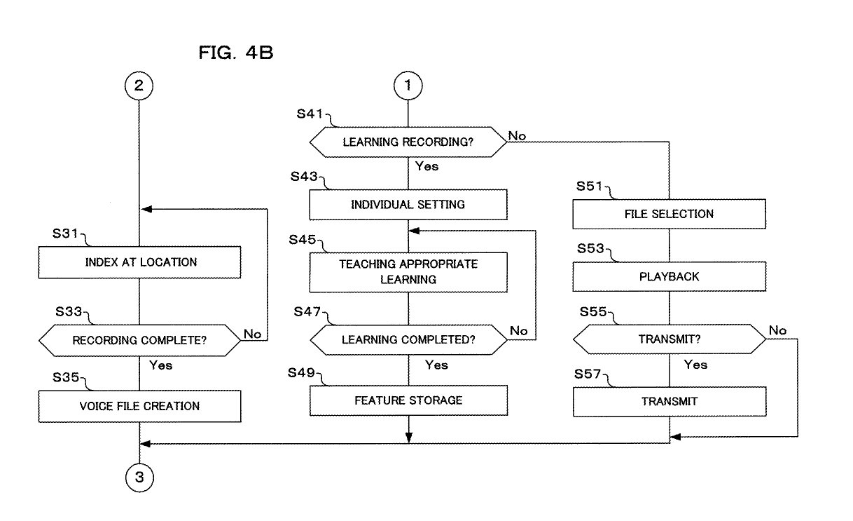

The format information 25b is a dictionary that is used when creating a document. The document making section 21b creates a document 30 by formatting text in accordance with the format information 25b (refer to S71 in FIG. 5).

A speech table 25c is characteristic information of a microphone etc. When converting from voice data to phonemes etc. in the text making section 24, characteristics of a microphone etc. stored in the speech table 25c are read out, and conversion is performed using this information. Besides this, information that is used when converting from voice data to phonemes is stored in the speech table 25c for every microphone. Speech characteristics may also be stored for every specified individual.

A display section 26 has a display control circuit and a display monitor, and also acts as a display section of the PC 50. Various modes that are set using the operation section 6 and documents that have been created by the document making section 21b are displayed on this display section 26.

The control section 21 has a CPU and CPU peripheral circuits, and performs overall control of the dictation section 20 in accordance with programs that have been stored in the recording section 25. The document making section 21b is provided inside the control section 21, and this document making section 21b is realized in software by the CPU and programs. It should be noted that the document making section 21b may also be implemented in a hardware manner by peripheral circuits within the control section 21. Also, in a case where the dictation section 20 is realized by the PC 50, a control section including the CPU etc. of the PC 50 may be concurrently used as the control section 21.

The document making section 21b creates documents from text that has been converted by the text making section 24, using format information 25b (refer to S71 in FIG. 5). A document 30 refers to one example of a document that has been created by the document making section 21b. The example shown by the document 30 is a medical record created in a hospital, in which patient name (or ID), age, gender, affected area, doctor's findings, creation date (date of storing speech, document creation date) etc. that have been extracted from text on the basis of voice data are inserted.

The recording and reproduction device 40 is equivalent to the previously described dictation unit, and a person listens to speech to create a document based on this speech. Specifically, a typist 55 plays back speech using the recording and reproduction device 40, and can create a transcript (document) by inputting characters using a keyboard of an input section 44.

A communication section 41 has communication circuits such as a transmission circuit/reception circuit, and performs communication with a communication section 5 of the information acquisition unit 10 to receive voice data etc. that has been acquired by the information acquisition unit 10. Communication with the information acquisition unit 10 may be wired communication performed by electrically connecting using communication cables, and may be wireless communication performed using radio waves or light etc.

A speech playback section 42 has a speech playback circuit and a speaker etc., and plays back voice data that has been acquired by the information acquisition unit 10. At the time of playback, it is advantageous if the user utilizes indexes etc. that have been set by the track input section 1b. For playback operation, the recording and reproduction device 40 has operation members such as a playback button, a fast-forward button and a fast rewind button etc.

The input section 44 is a keyboard or the like, and is capable of character input. In a case where the PC 50 doubles as the recording and reproduction device 40, the input section 44 may be the keyboard of the PC 50. Also, the storage section stores information (documents, transcripts) such as characters that have been input using the input section 44. Besides this, it is also possible to store voice data that has been transmitted from the information acquisition unit 10.

Next, a microphone that is provided in the sound collection section 2 within the information acquisition unit 10 will be described using FIG. 2. FIG. 2 is a cross-sectional drawing showing arrangement of two microphones and a retaining structure for these two microphones, in a case where a noise removal microphone is provided within the information acquisition unit 10.

A first microphone 102 is a microphone for acquiring speech from a front surface of the information acquisition unit 10. The first microphone 102 is arranged inside a housing 101, and is held by an elastic holding section 102b. Specifically, one end of the elastic holding section 102b is fixed to the housing 101, and the first microphone 102 is in a state of being suspended in space by the elastic holding section 102b. The elastic holding section 102b mitigates against sounds of the user's fingers rubbing etc. that pass through the housing 101 being picked up by the first microphone 102.

The first microphone 102 can perform sound acquisition of speech of a sound acquisition range 102c. A filter section 103 is arranged close to this sound acquisition range 102c at a position that is a distance Zd apart from the first microphone 102. The filter section 103 is a filter for reducing pop noise such as breathing when the user has spoken towards the first microphone 102. This filter section 103 is arranged slanted at a sound acquisition angle θ with respect to a horizontal line of the housing 101, in one corner of the four corners of the housing 101. It should be noted that width of the sound acquisition range 102c can be changed by the user using a known method.

Thickness Zm of the housing 101 is preferably made as thin as possible in order to make the information acquisition unit 10 small and easy to use. However, if a distance Zd between the first microphone 102 and the filter section 103 is made short expiratory airflow will be affected. The thickness Zm is therefore made thin to the extent that distance Zd does not affect voice airflow.

A second microphone 105 is a microphone for acquiring ambient sound (unwanted noise) from a rear surface of the information acquisition unit 10. The second microphone 105 acquires not the users speech but ambient sound (undesired noise) in the vicinity, and removing ambient sound from voice data that has been acquired by the first microphone 102 results in clear speech at the time of playback.

The second microphone 105 is arranged inside the housing 101, is held by an elastic holding section 105b, and is fixed to the housing 101 by means of this elastic holding section 105b. The second microphone 105 can perform sound acquisition of speech in the vicinity of a sound acquisition range 105c. Also, the second filter section 106 is arranged at the housing 101 side of the second microphone 105. The second filter section 106 has different unwanted noise removal characteristics to the filter section 103.

Depending on the filter section 103 and the second filter section 106, characteristics at the time of speech gathering are different, and further, recording characteristics of the first microphone 102 and the second microphone 105 are also different. These characteristics are stored in the file information section 9. There may be cases where speech at a given frequency is missed due to filter characteristics, and at the time of recording the sound quality adjustment section 7 performs sound quality adjustment by referencing this information.

As well as previously described components such as the first microphone 102 and the second microphone 105, a component mounting board 104 for circuits constituting each section within the information acquisition unit 10 etc. is also arranged within the housing 101. The information acquisition unit 10 is held between the user's thumb 202 and forefinger 203 so that the user's mouth 201 faces towards the first microphone 102. Height Ym of the sound acquisition section is a length from the side of one end of the second filter section 106 of the second microphone 105 to the filter section 103 of the first microphone 102. The elastic holding section 105b of the second microphone employs a cushion member that is different to the first microphone 102 for height countermeasures. Specifically, with this embodiment, by making the elastic holding section 105b of the second microphone 105 a molded material arm structure it is intended to make the elastic holding section 105b shorter in the longitudinal direction than the elastic holding section 102b of the first microphone 102, make the height Ym small, and reduce overall size.

In this way, the first microphone 102 and the second microphone 105 are provided within the information acquisition unit 10 as a main microphone and sub-microphone, respectively. The second microphone 105 that is the sub-microphone and the first microphone 102 that is the main microphone are at subtly different distances from a sound source, even if there is speech from the same sound source, which means that there is phase offset between the two sets of voice data. It is possible to electrically adjust a sound acquisition range by detecting this phase offset. That is, it is possible to widen and narrow the directivity of the microphones.

Also, the second microphone 105 that is the sub-microphone mainly performs sound acquisition of ambient sound that includes noise etc. Then, by subtracting voice data of the second microphone 105 that is the sub-microphone from voice data of the first microphone 102 that is the main microphone noise is removed and it is possible to extract a voice component.

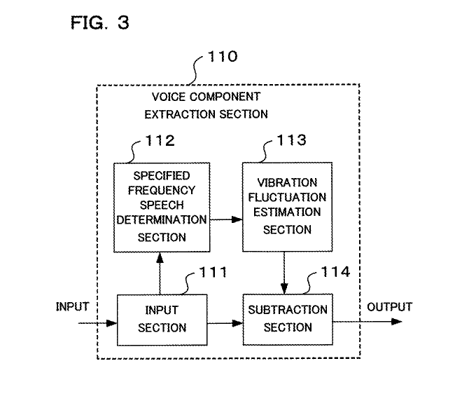

Next a voice component extraction section 110 that removes ambient sound (unwanted noise) using one microphone and extracts only a voice component will be described using FIG. 3. The voice component extraction section 110 is part of the sound quality adjustment section 7. As was described previously, the information acquisition unit 10 shown in FIG. 2 can extract only a voice component using speech signals from two microphones, namely the first microphone 102 and the second microphone 105. However, by using the voice component extraction section 110 such as shown in FIG. 3, it is possible to remove noise and extract a voice component with provision of only a single microphone.

The voice component extraction section 110 show in FIG. 3 comprises an input section 111, a specified frequency speech determination section 112, a vibration fluctuation estimation section 113, and a subtraction section 114. Some or all of the sections within the voice component extraction section 110 are constructed with hardware circuits or realized using software.

The input section 111 has an input circuit, is input with an electrical signal that has been converted by a microphone that acquires speech of a user, which is equivalent to the first microphone 102, and subjects this electrical signal to various processing such as amplification and AD conversion. Output of this input section 111 is connected to the specified frequency speech determination section 112. The specified frequency speech determination section 112 has a frequency component extraction circuit, and extracts frequency components that are equivalent to ambient sound other than the user's voice (unwanted noise) then outputs to the vibration fluctuation estimation section 113.

The vibration fluctuation estimation section 113 has a vibration estimation circuit, and estimates vibration a given time later based on frequency component determination results that have been extracted by the specified frequency speech determination section 112, and outputs an estimated value to the subtraction section 114. The extent of a delay time from output of voice data from the input section 111 to performing subtraction in the subtraction section 114 may be used as a given time. It should be noted that when performing subtraction in real time, the given time may be 0 or a value close to 0.

The subtraction section 114 has a subtraction circuit, and subtracts an estimated value for a specified frequency component that has been output from the vibration fluctuation estimation section 113 from voice data that has been output from the input section 111, and outputs a result. This subtracted value is equivalent to clear speech that results from having removed ambient sound (unwanted noise) in the vicinity from the user's speech.

In this way, in the event that noise removal is performed by the voice component extraction section shown in FIG. 3, it is possible to decrease the microphones provided in the information acquisition unit 10 to one. This means that it is possible to make the information acquisition unit 10 small in size.

It should be noted that description has been given for only the first microphone 102, instead of providing two microphones, as shown in FIG. 2, and noise removal is performed by arranging a voice component extraction section as shown in FIG. 3 for this first microphone 102. However, besides this structure the information acquisition unit 10 shown in FIG. 2 and the voice component extraction section 110 shown in FIG. 3 may be combined. In this case, noise removal is performed by the voice component extraction section 110 shown in FIG. 3, and a sub-microphone performs adjustment of sound collecting range that uses phase. Also, the noise removal of FIG. 2 is performed using ambient sound (noise, all frequencies) that has been the subject of sound acquisition by the sub-microphone, while the noise removal of FIG. 3 is performed for specified frequency components, and the methods of noise removal are different. Accordingly noise removal may also be performed by combining the two noise removal methods.

Next, recording processing of the information acquisition unit 10 will be described using the flowcharts shown in FIG. 4A and FIG. 4B. This flow is executed by the CPU within the control section 1 controlling each section within the information acquisition unit 10 in accordance with programs stored in the storage section 3.

If the flow of FIG. 4A is started, it is first determined whether or not there is recording (S1). Here, determination is based on whether or not the user has operated a recording button of the operation section 6.

If the result of determination in step S1 is that recording has commenced, it is next determined whether or not directivity is strong (S3). By operating the operation section 6 the user can narrow the range of directivity of the first microphone 102. In this step it is determined whether or not the directivity of the microphone has been set narrowly. It should be noted that in the event that the previously described first mode has been set, it will be determined that directivity is weak in step S3, while if the second or third modes have been set it will be determined that directivity is strong.

If the result of determination in step S3 is that directivity is strong, it is next determined whether or not a transcriber unit is to be used (S5). As was described previously, in creating a transcript there is a method in which speech that has already been recorded is played back using the playback and recording device 40, and characters are input by a person listening to this reproduced sound and using a keyboard (transcriber unit: Yes), and a method of automatically converting speech to characters mechanically using a dictation section 20, that is, using speech recognition (transcriber unit: No), and in this embodiment either of these methods can be selected. It should be noted that in the event that the previously described second mode has been set, transcriber unit No predetermined, while in the event that the third mode has been set transcriber unit Yes will be determined.

If the result of determination in step S5 is that a transcriber unit is not to be used, specifically, that voice data is converted to text by the dictation section 20 using speech recognition, noise estimation or determination is performed (S7). Here, estimation (determination) of noise during recording of the user's voice is performed based on ambient sound (unwanted noise) that has been acquired by the second microphone 105. Generally, since ambient sound (unwanted noise) is regularly at an almost constant level, it is sufficient to measure ambient sound (unwanted noise) at the time of recording commencement etc. However, if noise estimation (determination) is also performed during recording it is possible to increase accuracy of noise removal. Also, instead of, or in addition to, the above described method, noise estimation may also be performed using the specified frequency speech determination section 112 and vibration fluctuation estimation section 113 of the voice component extraction section 110 shown in FIG. 3.

If noise estimation or determination has been performed, next successive adaptive noise removal is performed less intensely (S9). Successive adaptive noise removal is the successive detection of noise, and successive performing of noise removal in accordance with a noise condition. Here, the sound quality adjustment section 7 performs weakening of the intensity of the successive adaptive type noise removal. Also, in a case where voice data is converted to text using speech recognition, if the intensity of noise removal is strengthened there is undesired change to the speech (phoneme) waveform, and it is not possible to accurately perform speech recognition. Intensity of the noise removal is therefore weakened, to keep the speech waveform as close to the original as possible. As a result it is possible to perform noise removal that is suitable for performing speech recognition by the dictation section 20.

The successive adaptive type noise removal of step S9 is performed by the sound quality adjustment section 7 subtracting voice data of the sub-microphone (second microphone 105) from voice data of the main microphone (first microphone 102), as shown in FIG. 2. In this case, a value of voice data of the sub-microphone is not subtracted directly, and instead a value that has been multiplied by a weighting coefficient is subtracted. Although successive adaptive noise removal is performed in step S19, which will be described later, compared to the case of step S19 the intensity of noise removal here has been made small by making a value of the weighting coefficient for multiplication small.

Also, in step S9, instead of or in addition to the successive adaptive noise removal, individual feature emphasis type noise removal may also be performed. Individual feature emphasis type noise removal is the sound quality adjustment section 7 performing noise removal in accordance with individual speech characteristics that are stored in the file information section 9 (or storage section 3). Recording adjustment may also be performed in accordance with characteristics of a device, such as microphone characteristics.

If successive adaptive noise removal has been performed in step S9, next frequency band adjustment is performed (S10). Here, the sound quality adjustment section 7 performs adjustment of a band for the voice data. Speech processing is applied to give a speech band for voice data (for example 200 Hz to 10 kHz) that is appropriate for performing speech recognition by the dictation section 20.

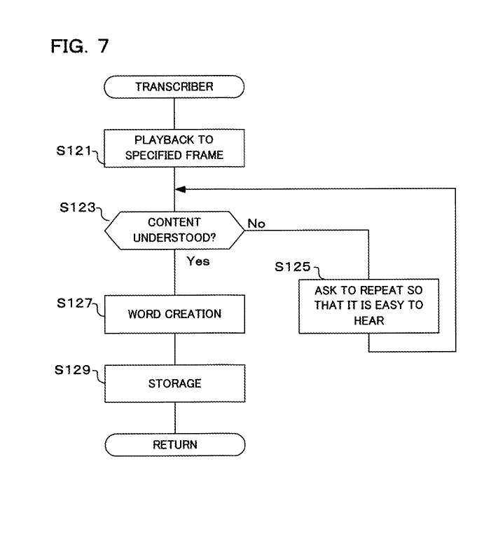

Once frequency band adjustment has been carried out in step S10, next removal noise for complementation that will be used when performing phoneme determination is stored (S11). As was described previously, noise removal is carried out in step S9. In a case where phonemes are determined using voice data, if noise is removed too aggressively accuracy will be lowered. Therefore, in this step noise that has been removed is stored, and when performing phoneme determination it is possible to restore the voice data. At the time of restoration, it is not necessary to restore all voice data from start to finish, and it is possible to generate a speech waveform that gradually approaches the original waveform, and to perform phoneme determination each time a speech waveform is generated. Details of noise removal and storage of removed noise for complementation will be described later using FIG. 8A to FIG. 8D.

If removed noise has been stored, it is next determined whether or not recording is finished (S13). In the event that the user finishes recording, an operation member of the operation section 6, such as a recording button, is operated. In this step determination is based on operating state of the recording button. If the result of this determination is not recording finish, processing returns to step S7, and the recording for transcript creation (for dictation) using speech recognition continues.

If the result of determination in step S13 was recording finish, next voice file creation is performed (S15). During recording, voice data that has been acquired by the sound collection section 2, and subjected to sound quality adjustment, such as noise removal and frequency band adjustment by the sound quality adjustment section 7, is temporarily stored. If recording is completed, the temporarily stored voice data is made into a file, and the voice file that has been generated is stored in the storage section 3. The voice file that has been stored is transmitted via the communication section 5 to the dictation section 20 and/or the recording and reproduction device 40.

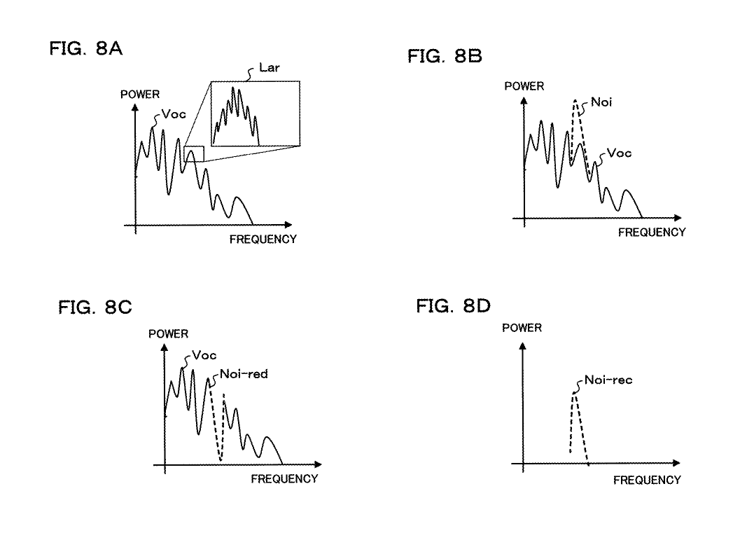

Also, when making the voice file in step S15, microphone characteristics and restoration information are also stored. If phoneme determination and speech recognition etc. have been performed in accordance with various characteristics, such as microphone frequency characteristics, accuracy is improved. Removed noise that was temporarily stored in step S11 is also stored along with the voice file when generating a voice file. The structure of the voice file will be described later using FIG. 9.

Returning to step S5, in the event that the result of determination in this step was transcriber unit, namely that a user plays back speech using the playback and recording device 40 and creates a transcript (document) by listening to this reproduced sound, first, noise estimation or determination is performed (S17). Here, similarly to step S7, noise estimation or noise determination is performed.

Next, successive adaptive noise removal is performed (S19). Here, similarly to step S9, noise is successively detected, and successive noise removal to subtract noise from speech is performed. However, compared to the case of step S9, by making a weighting coefficient large the level of noise removal is made strong so as to give clear speech. The successive adaptive noise removal of step S19 performs noise removal so as to give speech that is easy for a person to catch, when creating a transcript using a transcriber unit. This is because while, in the case of performing speech recognition, if noise removal is made strong a speech waveform will be more distorted than the original waveform, and precision of speech recognition will be lowered, in the case of a person listening to speech, it is easier to listen to if noise has been completely removed.

It should be noted that when subtracting a noise component, estimation may be performed after a given time (predicted component subtraction type noise removal), or noise removal may be performed in real-time, and how the noise removal is performed may be appropriately selected in accordance with conditions. For example, when recording with an information acquisition unit 10 placed in a person's pocket, there may be cases where noise is generated by the information acquisition unit and a person's clothes rubbing together. This type of noise varies with time, and so predicted component subtraction type noise removal is effective in removing this type of noise.

If successive adaptive noise removal has been performed, next frequency band adjustment is performed (S20). Frequency band adjustment is also performed in step S10, but when playing back speech using the playback and recording device 40, speech processing is applied so as to give a speech band of voice data (400 Hz to 8 kHz) that is easy to hear and results in clear speech.

Next, an index is stored at a location (S21). Here, an index for cueing, when playing back voice data that has been stored, is stored. Specifically, since the user operates an operation member of the operation section 6 at a location where they wish to cue, an index is assigned to voice data in accordance with this operation.

If an index has been assigned, it is next determined whether or not recording is completed (S23). Here, similarly to step S13, determination is based on operating state of the recording button. If the result of this determination is not recording complete, processing returns to step S17.

On the other hand, if the result of determination in step S23 is recording complete, next voice file creation is performed (S25). Here, voice data that has been temporarily stored from commencement of recording until completion of recording is made into a voice file. The voice file of step S15 stores information for recognizing speech using a machine (for example, microphone characteristics, restoration information), in order to create a transcript using speech recognition. However, since speech recognition is not necessary in this case, these items of information may be omitted.

Returning to step S3, if the result of determination in this step is that directivity is not strong (directivity is wide), the recording of step S31 and onwards is performed regardless of whether or not a transcript is created using a transcriber unit and without performing particular noise removal. Generally, in order to create a transcript from speech of a single speaker using speech recognition, strengthening of directivity (narrow range) is performed in order to focus on the speaker. Conversely, in a case of sound acquisition of ambient speech of a meeting or the like from a wide range, it is preferable to record in a different mode.

First, similarly to step S21, an index is assigned at a location (S31). As was described previously, an index for cueing is assigned to voice data in response to user designation. Next it determined whether or not there is recording completion (S33). Here, similarly to steps S13 and S23, determination is based on whether or not the user has performed an operation for recording completion. If the result of this determination is not recording complete, processing returns to step S31. On the other hand, if the result of determination in step S33 is recording complete, then similarly to step S25 making of a voice file is performed (S35).

Returning to step S1, if the result of determination in this step is that recording is not performed, is determined whether or not there is recording for learning (S41). Here it is determined whether or not there is learning in order to detect individual features, in order to perform the individual feature emphasis type noise removal of step S9. Since the user selects this learning mode by operating an operation member of the operation section 6, in this step ii is determined whether or not operation has been performed using the operation section 6.

If the result of determination in step S41 is that learning recording is carried out, individual processing is performed (S43). Here, information such as personal name of the person performing learning is set.

If individual setting has been performed, next learning using pre-prepared text is performed (S45). When detecting individual features, a subject is asked to read aloud pre-prepared text, and speech at this time is subjected to sound acquisition. Individual features are detected using voice data that has been acquired by this sound acquisition.

Next it is determined whether or not learning has finished (S47). The subject reads out all teaching materials that were prepared in step S45, and determination here is based on whether or not it was possible to detect individual features. If the result of this determination is that learning is not finished, processing returns to step S45 and learning continues.

On the other hand, if the result of determination in step S47 is that learning has finished, features are stored (S49). Here, individual features that were detected in step S45 are stored in the storage section 3 or the file information section 9. The individual feature emphasis type noise removal of step S9 is performed using the individual features that have been stored here. The individual features are transmitted to the dictation section 20 by means of the communication section 5, and may be used at the time of speech recognition.

Returning to step S41, if the result of determination in this step is that there is no recording for learning, processing is performed to transmit a voice file that has been stored in the storage section 3 to an external device such as the dictation section 20 or the recording and reproduction device 40. First, file selection is performed (S51). Here, a voice file that will be transmitted externally is selected from among voice files that are stored in the storage section 3. If a display section is provided in the information acquisition unit 10, the voice file may be displayed on this display section, and if there is not a display section in the information acquisition unit 10 the voice file may be displayed on the PC 50.

If a file has been selected, play back is performed (S53). Here, the voice file that has been selected is played back. If a playback section is not provided in the information acquisition unit 10, this step is omitted.

It is then determined whether or to transmit (S55). In the event that the voice file that was selected in step S51 is transmitted to an external unit such as the dictation section 20 or the recording and reproduction device 40, the operation section 6 is operated, and after a destination has been set the transmission button is operated.

If transmission has been performed in step S57, or if features have been stored in step S49, or if the result of determination in step S47 is that learning is not finished, and a voice file is created in steps S35, S25 and S15, this flow is terminated.

In this way, in the flow shown in FIG. 4A and FIG. 4B, depending on whether a document is created by a user listening to speech while it is being played back, or a document is created mechanically using speech recognition, the sound quality adjustment section 7 performs noise removal and adjustment of speech frequency bands in accordance with respective characteristics (refer to steps S9, S10, S19 and S20).

Also, in the event that noise removal is performed, compared to creation of a transcript by speech recognition, the level of noise removal is made stronger when creating a transcript using a transcriber unit while the user is listening to reproduced sound (refer to steps S9 and S19). This is because if noise removal is made strong accuracy of speech recognition is lowered, but speech becomes clear. Conversely intensity of noise removal is made weaker for transcript using speech recognition.

Also, in the case of performing adjustments of frequency bands, compared to creation of a transcript using a transcriber unit, a frequency band is made wider for creation of a transcript using speech recognition (refer to steps S10 and S20). Specifically, taking a lower cut-off frequency, lower cut-off frequency is lower for a transcript using speech recognition. This is because in the case of speech recognition, in order to be able to identify phonemes using voice data in a wide frequency band makes it more possible to increase accuracy.

Also, when performing recording for machine type speech recognition in step S7 and onwards, recording adjustment is performed in accordance with unit characteristics such as microphone characteristics (refer to step S9). As a result, since it is possible to take characteristics of the microphone into consideration, it is possible to perform highly accurate speech recognition.

Also, when performing noise removal the original voice data is distorted, and accuracy of speech recognition is lowered. With this embodiment therefore, voice data such as a waveform of noise that has been removed, is stored (refer to step S11). At the time of speech recognition, by restoring voice data using this removed noise data that has been stored, it is possible to improve accuracy of speech recognition.

Also, in the case of recording for transcript creation using speech recognition, when generating a voice file from voice data, microphone characteristics and/or restoration information is also stored together with the voice file (refer to step S15 and FIG. 9). At the time of speech recognition it is possible to improve accuracy of speech recognition by using these items of information that have been stored in the voice file.

Also, for a case where microphone directivity is strong (a case where directivity is narrow), a method of noise removal is changed in accordance with whether or not a transcriber unit (or dictation unit) is used. When the user performs recording for transcript creation, recording is focused on speech by setting directivity wide if there is little noise, while on the other hand setting directivity narrow if there is a lot of noise. In the event that microphone directivity is strong (narrow) (refer to step S3), it is assumed that there is a noisy environment. The noise removal method is therefore changed in accordance with whether or not a transcriber unit is used (refer to step S5).

Also, recording for learning is performed in order to carry out individual feature emphasis type noise removal (S41 to S49). Since there are subtleties in the way of speaking for every individual, by performing speech recognition in accordance with these subtleties it is possible to improve the accuracy of speech recognition.

It should be noted that with this embodiment either recording of step S7 onward is executed or the recording of step S17 and onward is executed, in accordance with whether or not a transcriber unit (or dictation unit) is used in step S5, and either one is alternatively executed. However, this is not limiting, and the recording of step S7 and onward and the recording of step S17 and onward may be performed in parallel. In this case, it is possible to simultaneously acquire voice data for the transcriber unit and voice data for the dictation unit, and it is possible to select a method for the transcript after recording is completed.

Also, when acquiring voice data for the transcriber unit and voice data for the dictation unit, noise removal and frequency band adjustment are performed in both cases. However, it is not necessary to perform both noise removal and frequency band adjustment, or only one may be performed.

Next, creation of a transcript in the dictation section 20 or the recording and reproduction device 40 will be described using the flowchart show in FIG. 5. In the case of a dictation section 20, this flow is realized by the CPU within the control section 21 controlling each section within the dictation section 20 in accordance with programs that have been stored in the recording section 25. Also, in the case of a recording and reproduction device 40, this flow is realized by the CPU that has been provided in the control section within the recording and reproduction device 40 controlling each section within the recording and reproduction device 40 in accordance with programs that have been stored within the recording and reproduction device 40.

If the flow shown in FIG. 5 is commenced, it is first determined whether or not a file has been acquired (S61). The information acquisition unit 10 transmits a voice file that was selected in step S57 to the dictation section 20 or the playback and recording device 40. In this step it is determined whether or not the voice file has been transmitted. If the result of this determination is that a file has not been acquired, acquisition of a file is awaited (S63).

If the result of determination in step S61 is that a voice file has been acquired, speech playback is performed (S65). The speech playback section 42 within the recording and reproduction device 40 plays back the voice file that was acquired. Also, the dictation section 20 may have a playback section, and in this case speech is played back for confirmation of the voice file that was acquired. It should be noted that in the case that there is not a speech playback section, this step may be omitted.

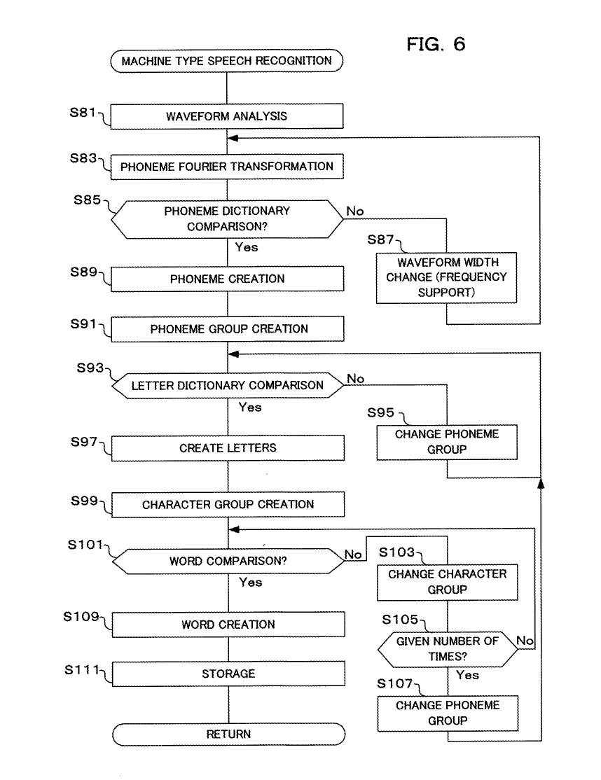

Next, the voice data is converted to characters (S67). In a case where the text making section 24 of the dictation section 20 creates a transcript, speech recognition for the voice data that was acquired by the information acquisition unit 10 is performed, followed by conversion to text data. This conversion to text data will be described later using FIG. 6. Also, conversion to text may involve input of characters by the user operating a keyboard or the like of the input section 44 while playing back speech using the recording and reproduction device 40 (transcriber unit). This creation of a transcription that is performed using the transcriber unit will be described later using FIG. 7. A

If the voice data has been converted to characters, it is next determined whether or not item determination is possible (S69). This embodiment assumes, for example, that content spoken by a speaker is put into a document format with the contents being described for every item, such as is shown in the document 30 of FIG. 1. In this step it is determined whether or not characters that were converted in step S67 are applicable as items for document creation. It should be noted that items used for document creation are stored in the format information 25b of the recording section 25.

If the result of determination in step S69 is that item determination is possible, a document is created (S71). Here, a document that is organized for each item like the document 30 of FIG. 1, for example, is created in accordance with the format information 25b.

On the other hand, if the result of determination in step S69 is that item determination cannot be performed, a warning is issued (S73). In a case where, on the basis of voice data, it is not possible to create a document, that fact is displayed on the display section 26. If a warning is issued, processing returns to step S65, and until item determination is possible conditions etc. for converting to characters in step S67 may be modified and then conversion to characters performed, and the user may manually input characters.

If a document has been created in step S71, it is next determined whether or not the flow for transcription is completed (S75). If a transcriptionist has created a document using all of the voice data, or if the user has completed a dictation operation that used speech recognition with the dictation section 20, completion is determined. If the result of this determination is not completion processing returns to step S65 and the making of characters and creation of a document continue.

If the result of determination in step S75 is completion, storage is performed (S77). Here, a document that was generated in step S71 is stored in the recording section 25. If a document has been stored, processing returns to step S61.

In a case where the transcriptionist performs creation of a document using the recording and reproduction device 40, the processing of steps S69 to S75 is judged and performed manually by a person.

In this way, in the flow shown in FIG. 5, voice data is converted to characters (refer to step S67), and a document is created from the converted characters (refer to steps S69 and S71) in accordance with a format that has been set in advance (refer to the format information 25b in FIG. 1). This means that it is possible to make a document in which content that has been spoken by a speaker has been arranged in accordance with items. It should be noted that if it is only necessary to simply convert voice data to characters, steps S69 to S73 may be omitted.

Next, operation in a case where the character generating of step S67 is realized using the dictation section 20 will be described using the flowchart shown in FIG. 6. This operation is realized by the CPU within the control section 21 controlling each section within the dictation section 20 in accordance with programs that have been stored in the recording section 25.

If the flow shown in FIG. 6 is commenced, waveform analysis is first performed (S81). Here, the text making section 24 analyzes a waveform of the voice data that has been transmitted from the information acquisition unit 10. Specifically, the waveform is decomposed at a time when there is a phoneme break, for the purpose of phoneme Fourier transformation in the next step. A phoneme is equivalent to a vowel or a consonant etc., and the waveform decomposition may be performed by breaking at the timing of the lowest point of a voice data intensity level.

If waveform analysis has been performed, next a phoneme is subjected to Fourier Transformation (S83). Here, the text making section 24 subjects voice data for phoneme units that have been subjected to waveform analysis in step S81 to Fourier Transformation.

If phoneme Fourier transformation has been performed, next phoneme dictionary collation is performed (S85). Here, the data that was subjected to phoneme Fourier Transformation in step S83 is subjected to collation using the phoneme dictionary that has been stored in the recording section 25.

If the result of determination in step S85 is that there is no match between the data that has been subjected to Fourier Transformation and data contained in the phoneme dictionary, waveform width is changed (S87). The fact that there is no data that matches the phoneme dictionary is because there is a possibility that waveform width at the time of waveform analysis in step S81 was not adequate, and so waveform which is changed, processing returns to step S83, and phoneme Fourier Transformation is performed. Also, frequency support is performed instead of waveform width change or in addition to waveform width change. Since a noise component has been removed from the voice data, the waveform is distorted, and that may be cases where it is not possible to decompose the waveform into phonemes. Therefore, by performing frequency support voice data that has not had the noise component removed is restored. Details of this frequency support will be described later using FIG. 8A and FIG. 8D.

If the result of determination in step S85 is that there is data that matches the phoneme dictionary, that data is converted to a phoneme (S89). Here, voice data that was subjected to Fourier Transformation in step S83 is replaced with a phoneme based on the result of dictionary collation in step S85. For example, if speech is Japanese, the voice data is replaced with a consonant letter (for example “k”) or a vowel letter (for example “a”). In the case of Chinese, the voice data may be replaced with Pinyin, and in the case of other languages, such as English, the voice data may be replaced with phonetic symbols. In any event, the voice data may be replaced with the most appropriate phonemic notation for each language.

If conversion to phonemes has been performed, next a phoneme group is created (S91). Since the voice data is sequentially converted to phonemes in steps S81 to S89, a group of these phonemes that have been converted is created. In this way the voice data becomes a group of vowel letters and consonant letters.

If a phoneme group has been created, next collation with a character dictionary is performed (S93). Here the phoneme group that was created in step S93 and the speech to text dictionary 25a are compared, and it is determined whether or not the phoneme group matches speech text. For example, in a case where voice data has been created from Japanese speech, if a phoneme group “ka” has been created from the phonemes “k” and “a” in step S91, then if this phoneme group is collated with the character dictionary “ka” will match with Japanese characters that are equivalent to “ka”. In the case of languages other than Japanese, it may be determined whether it is possible to convert to characters in accordance with the language. In the case of Chinese, conversion to characters is performed taking into consideration the fact that there are also four tones as phonemes. Also, in the event that it is not possible to convert from a phoneme group to characters on a one to one basis, steps S97 and S99 may be skipped and a phoneme notation group itself converted to words directly.

If the result of determination in step S93 is that the character dictionary has been collated and that there is not a matching phoneme group, the phoneme group is changed (S95). In this case the result of having collated the phoneme group and all characters is that there is not a character that matches, and a combination of phoneme groups is changed. For example, in a case where there has been a collation of “sh” with the character dictionary, if there is no character to be collated then if the next phoneme is “a” then “a” is added, to change the phoneme group to “sha”. If the phoneme group has been changed, processing returns to step S93, and character collation is performed again.

On the other hand, if the result of determination in step S93 is that as a result of collation with the character dictionary there is a matching phoneme group, character generation is performed (S97). Here the fact that a character matches the dictionary is established.

If character generation has been performed, next a character group is created (S99). Every time collation between the phoneme group and the character dictionary is performed in step S93, the number of characters forming a word increases. For example, in the case of Japanese speech, if “ka” is initially determined, and then “ra” is determined with the next phoneme group, “kara” is determined as a character group. Also, if “su” is determined with the next phoneme group then “karasu” (meaning “crow” in English) is determined as a character group.

If a character group has been created, collation of the character group with words is next performed (S101). Here, the character group that was created in step S99 is collated with words that are stored in the speech to text dictionary 25a, and it is determined whether or not there is a matching word. For example, in the case of Japanese speech, even if “kara” has been created as a character group, if “kara” is not stored in the speech to text dictionary 25a it will be determined that a word has not been retrieved.

If the result of determination in step S101 is that there is not a word that matches the character group, the character group is changed (S103). In the event that there is no matching word, the character group is combined with the next character. The combination may also be changed to be combined with the previous character.

If the character group has been changed, it is determined whether or not a number of times that processing for word collation has been performed has exceeded a given number of times (S105). Here, it is determined whether or not a number of times that word collation has been performed in step S101 has exceeded a predetermined number of times. If the result of this determination is that the number of times word collation has been performed does not exceed a given number, processing returns to step S101 and it is determined whether or not the character group and a word match.

On the other hand, if the result of determination in step S105 is that the number of times that word collation has been performed exceeds a given number of times, the phoneme group is changed (S107). Here, since the phoneme group that was created in step S91 is wrong, it is determined that there is not a word that matches the character group, and the phoneme group itself is changed. If the phoneme group has been changed, processing returns to step S93 and the previously described processing is executed.

Returning to step S101, if the result of determination in this step is that there is a word that matches the character group, word creation is performed (S109). Here it is determined that a word matches the dictionary. In the case of Japanese, this may be determined by converting to a kanji character.

If a word has been determined, it is then stored (S111). Here, the word that has been determined is stored in the recording section 25. It should be noted that every time a word is determined, words may be sequentially displayed on the display section 26. In the event that there are errors in words that have been displayed the user may successively correct these errors. Further, the dictation section 20 may possess a learning function, so as to improve accuracy of conversion to phonemes, characters and words. Also, in a case where a word has been temporarily determined, and it has been determined to be erroneous upon consideration of the meaning within text, that word may be automatically corrected. Also, in the case of kanji, there may be different characters for the same sound, and in the case of English etc. there may be different spellings for the same sound, and so these may also be automatically corrected as appropriate. Once storage has been performed, the original processing flow is returned to.

In this way, the machine type speech recognition using the dictation section 20 of this embodiment involves waveform analysis of voice data that has been acquired by the information acquisition unit 10, and extraction of phonemes by subjecting this voice data that has been analyzed to Fourier Transformation (S81 to S89). In a case where it is not possible to extract a phoneme by Fourier Transformation, waveform width at the time of waveform analysis is changed, and a waveform that was altered as a result of noise removal is restored to an original waveform (frequency support), and a phoneme is extracted again (S87). As a result, it is possible to improve conversion accuracy from voice data to phonemes.

Also, with this embodiment, phonemes are combined to create a phoneme group, and by comparing this phoneme group with a character dictionary it is possible to extract characters from the voice data (S91 to S97). Further, words are extracted from characters that have been extracted (S99 to S109). At the time of these extractions, in cases where it is not possible to extract characters (S93: No) and in cases where it is not possible to extract words (S101: No), the phoneme group and character group are changed (S95, S103, S105), and collation is performed again. As a result, it is possible to improve conversion accuracy from voice data to words. It should be noted that depending on the language, there may be differences in relationships between descriptions of phonemes and words, which means that processed items and processing procedures may be appropriately set until there is conversion from a phoneme to a word.

Next, processing in the transcriber unit for creating a transcript (document) while a person is listening to speech will be described using the flowchart shown in FIG. 7. In this flowchart speech is converted to a document by a user operating a keyboard or the like while playing back speech using the recording and reproduction device 40.

If the flow of the transcriber shown in FIG. 7 is commenced, first the user plays back speech as far as a specified frame (S121). As was described previously, when storing speech with the information acquisition unit 10, if creation of a document by the recording and reproduction device 40 (transcriber unit) is scheduled (Yes at S5 in FIG. 4A), noise removal is performed so that it is easy for a person to listen to the speech (S19 in FIG. 4A), adjustment of a frequency band is performed (S20 in FIG. 4A), and an index is assigned at a location (S21 in FIG. 4A). Here, the user operates the speech playback section 42 and plays back speech until a specified frame using the position of the index that has been assigned.

If playback has been performed, it is determined whether the user was able to understand the speech content (S123). There may be cases where it is not possible to understand speech content because there is a lot of noise etc. in the speech. If the result of this determination is that it is not possible for the user to understand the speech content, they can ask for it to be repeated to facilitate listening (S125). Here, listening is facilitated by the user changing playback conditions, such as playback speed, playback sound quality etc. Also, various parameters for playback of voice data that has been subjected to noise removal may also be changed.

If the result of determination in step S123 was that it was possible for the user to understand the content, the speech that was understood is converted to words (S127). Here, words that the user has understood are input by operating a keyboard etc. of the input section 44.

If speech has been converted to words, words that have been converted are stored in the storage section 43 of the recording and reproduction device 40 (S129). Once words have been stored, playback is next performed to a specified frame, and similarly, there is conversion to words and the converted words are stored in the storage section 43. By repeatedly perform this operation it is possible to convert speech to a document and store the document in the storage section 43.

In this way, the transcriber of this embodiment stores voice data such that it is easy and clear for the user to hear on playing back speech that has been stored. This means that, differing from voice data for machine type speech recognition, it is possible to playback with a sound quality such that it is possible for a person to create a document with good accuracy.

Next, the removed noise storage of S11 in FIG. 4A and the frequency support used in step S87 of FIG. 6 will be described using FIG. 8A to FIG. 8D.

FIG. 8A shows one example of a speech waveform Voc showing a power relationship for each frequency of the voice data, the horizontal axis being frequency and the vertical axis being power. The enlarged drawing Lar in FIG. 8A is an enlargement of part of the voice data, and as shown in that drawing power changes finely in accordance with frequency. This fine change is a feature of a person's voice, in other words, is a feature of phonemes. Specifically, when extracting phonemes etc. from voice data, it is not possible to perform accurate speech recognition without faithfully reproducing the waveform of power for each finely changing frequency.

FIG. 8B shows a case where noise Noi has been superimposed on the speech waveform Voc. In a case where a person creates a document by listening to speech (transcriber), if the noise Noi is superimposed on the speech waveform listening is difficult. Therefore, as shown in FIG. 8C, the noise Noi is removed from the speech waveform, and a noise reduced waveform Noi-red is generated.

This noise reduced waveform Noi-red has had the noise removed, and so is suitable for a transcriptionist playing back speech and converting to characters using a transcriber unit. However, as shown in the enlarged drawing Lar of FIG. 8A, since power of speech that changes finely in accordance with frequency is also removed, it is not suitable for performing speech recognition that is performed by the dictation section 20.

Therefore, the removed noise Noi-rec as shown in FIG. 8D is stores together with the voice data that has had noise removed. Then, in a case of performing speech recognition the voice data before removal is restored using voice data that has had noise removed and the removed noise Noi-rec (refer to the frequency support of S87 in FIG. 6). Using the removed noise Noi-rec it is also possible to correct voice data so as to gradually approach the original speech, and perform speech recognition every time correction is performed, without having to restore so as to achieve a 100% match with the original speech.

It should be noted that besides storing the removed noise Noi-rec, it is possible to store both the voice data that has had noise removed and voice data for which noise removal has not been performed, and to playback the voice data that has been subjected to noise removal when creating a transcript using the transcriber unit, while using the voice data for which noise removal has not been performed when performing speech recognition using the dictation unit.

Next, the structure of a voice file that is generated in step S15 of FIG. 4 will be described using FIG. 9. As was described previously, this voice file is a file when storing voice data that is suitable for performing machine type speech recognition. As shown in FIG. 9, in addition to filename, voice data and storage time and date information etc. that are normally stored, restoration information, microphone characteristic, noise removal (NR), directivity information etc. are stored

Restoration information is information for restoring to an original speech waveform when a speech waveform has been corrected using noise removal etc. There are different frequency characteristics depending on individual microphones, and microphone characteristic is information for correcting these individual differences in frequency characteristics. Noise removal (NR) information is information indicating the presence or absence of noise removal, and content of noise removal etc. Directivity information is information representing directional range of a microphone, as was described using FIG. 2. By correcting voice data using restoration information, microphone characteristics, noise removal information, directivity information etc. it is possible to improve accuracy of speech recognition.

Next, an example where switching between being used as a transcriber unit and being used as a dictation unit is performed automatically will be described using FIG. 10. FIG. 10A shows a state where a user is holding the information acquisition unit 10 in their hand 56, and FIG. 10B shows a state where the information acquisition unit 10 has been placed on a stand 10A.

In the state shown in FIG. 10A, since the attitude determination section 4 detects hand shake, the control section 1 determines it to be a state where the user is holding the information acquisition unit 10 in their hand. In this case, a user will often speak in to the device while facing towards the information acquisition unit 10. In this case therefore, it is determined that directivity is strong in step S3 in the flow of FIG. 4A, it is then determined that it is not a transcriber unit in step S5, and recording that is suitable for machine type speech recognition is performed in steps S7 and onwards.

On the other hand, in the state shown in FIG. 10B, since the attitude determination section 4 does not detect hand shake, the control section 1 determines it to be a state where the user has placed the information acquisition unit 10 in a stand 10A. In this case, then may be a plurality of speakers and speech from various directions. Therefore, in this case it is determined in step S3 of FIG. 4A that directivity is weak, and recording is performed in step S31 and onwards.

As has been described above, with the one embodiment of the present invention, when converting speech to voice data and storing that voice data, sound quality adjustment of the voice data (S9 and S19 in FIG. 4A) will be different in the case of creating a transcript by speech recognition (S5 No in FIG. 4), and in a case of a person creating a transcript by listening to speech S5 Yes in FIG. 4A). In a case where a user makes a document by listening to speech, and in a case where a machine converts speech to a transcript using speech recognition, it is possible to perform speech storage that is suitable for the respective characteristics.

It should be noted that with the one embodiment of the present invention, in a case where a transcript is created by speech recognition and in a case where a person creates a transcript by listening to speech, noise removal and frequency bands will be different when performing sound quality adjustment. However, the sound quality adjustment is not limited to noise removal and adjustment of frequency bands, and other sound quality adjustment items may also be made different, such as enhancement processing of specified frequency bands, for example. Also, sound quality adjustment may be performed automatically or manually set, taking into consideration whether the speaker is male or female, an adult or child, or a professional person such as an announcer, and also taking into consideration directivity etc.

Also, in the one embodiment of the present invention, the sound quality adjustment section 7, sound collection section 2, storage section 3, attitude determination section 4 etc. are constructed separately from the control section 1, but some or all of these sections may be constituted by software, and executed by a CPU within the control section 1. Also, each of the sections such as the sound quality adjustment section 7, as well as being constructed using hardware circuits, may also be realized by circuits that are executed using program code, such as a DSP (Digital Signal Processor), and may also have a hardware structure such as gate circuits that have been generated based on a programming language described using Verilog.

Also, some functions of the CPU within the control section 1 may be implemented by circuits that are executed by program code such as a DSP, may have a hardware structure such as gate circuits that are generated based on a programming language described using Verilog, or may be executed using hardware circuits.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they be downloaded via the Internet.

Also, with the one embodiment of the present invention, operation of this embodiment was described using flowcharts, but procedures and order may be changed, some steps may be omitted, steps may be added, and further the specific processing content within each step may be altered. It is also possible to suitably combine structural elements from different embodiments.

Also, regarding the operation flow in the patent claims, the specification and the drawings, for the sake of convenience description has been given using words representing sequence, such as “first” and “next”, but at places where it is not particularly described, this does not mean that implementation must be in this order.

As understood by those having ordinary skill in the art, as used in this application, ‘section,’ ‘unit,’ ‘component,’ ‘element,’ ‘module,’ ‘device,’ ‘member,’ ‘mechanism,’ ‘apparatus,’ ‘machine,’ or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. A speech acquisition device, comprising:
a microphone for converting speech to voice data;
and a sound quality adjustment circuit that adjusts sound quality of the voice data,
wherein
the sound quality adjustment circuit performs different sound quality adjustment for a case where a transcript is created using speech recognition and a case where a transcript is created by a person listening to speech.

2. The speech acquisition device of claim 1 wherein:
the sound quality adjustment circuit performs adjustment for removal of noise components that are superimposed on the voice data, or adjustment of frequency bands, and
further, the sound quality adjustment circuit uses a different degree of removal of noise components and a different method for removal of noise components, or uses different frequency bands, in a case where a transcript is created using speech recognition and in a case where a transcript is created by a person listening to speech.

3. The speech acquisition device of claim 1 further comprising:
a memory that stores sound acquisition characteristic information relating to sound acquisition characteristics of the microphone and/or restoration information, and wherein
the sound quality adjustment circuit performs different sound quality adjustment based on the sound acquisition characteristic information and/or the restoration information.

4. The speech acquisition device of claim 1 wherein:
the sound quality adjustment circuit performs removal of noise components that are superimposed on the voice data, and
further comprising a second memory that stores the noise components that have been removed.

5. The speech acquisition device of claim 1 wherein:
the microphone can have its directional range made different, and
the sound quality adjustment circuit makes sound quality adjustment different depending on directional range of the microphone.

6. The speech acquisition device of claim 1 further comprising:
storage that stores voice data that has been adjusted by the sound quality adjustment circuit, and wherein
the storage respectively stores two sets of voice data for which respectively appropriate sound quality adjustment has been performed, for a case where a transcript is created using speech recognition, and a case where a transcript is created by a person listening to speech, in parallel.

7. A speech acquisition method, comprising:
converting speech to voice data; and
performing different sound quality adjustment of the voice data for a case where a transcript is created using speech recognition and a case where a transcript is created by a person listening to speech.

8. The speech acquisition method of claim 7 further comprising:
adjusting removal of noise components that are superimposed on the voice data, or adjusting frequency bands, and
further, making a degree of removal of noise components and a method for removal of noise components different, or making frequency bands different, in a case where a transcript is created using speech recognition and in a case where a transcript is created by a person listening to speech.

9. The speech acquisition method of claim 7 comprising:
storing sound acquisition characteristic information relating to sound acquisition characteristics when converting the speech to voice data and/or restoration information in memory, and
making sound quality adjustment different based on the sound acquisition characteristic information and/or the restoration information.

10. The speech acquisition method of claim 7 comprising:
performing removal of noise components that are superimposed on the voice data, and
storing the noise components that have been removed in a second memory.

11. The speech acquisition method of claim 7 comprising:
being able to make directional range for sound acquisition of the voice data different, and
making sound quality adjustment different in accordance with the directional range.

12. The speech acquisition method of claim 7 comprising:
storing voice data that has been adjusted in storage; and
storing two sets of voice data for which respectively appropriate sound quality adjustment has been performed, for a case where a transcript is created using speech recognition, and a case where a transcript is created by a person listening to speech, in the storage, in parallel.

13. A non-transitory computer-readable medium storing a processor executable code, which when executed by at least one processor, performs a voice acquisition method, the voice acquisition method comprising:
converting speech to voice data; and
performing different sound quality adjustment of the voice data for a case where a transcript is created using speech recognition and a case where a transcript is created by a person listening to speech.
